(19) United States
(12) Patent Application Publication
(10) Pub. No.: US 2025/0245344 A1
(43) Pub. Date: Jul. 31, 2025

(54) PROACTIVE SECURITY ALERT GENERATION ACROSS ORGANIZATIONS

(71) Applicant: Google LLC, Mountain View, CA (US)

(72) Inventor: Anurag Singla, Cupertino, CA (US)

(21) Appl. No.: 18/425,486

(22) Filed: Jan. 29, 2024

(51) Int. Cl. G06F 21/57; G06F 21/55; G06F 21/56

(52) U.S. Cl. CPC G06F 21/577; G06F 21/554; G06F 21/566

(57) ABSTRACT

A method includes detecting a plurality of first malicious activities associated with a first attack. The method further includes detecting a plurality of second malicious activities associated with a second attack. The method further includes predicting, based on the plurality of first malicious activities associated with the first attack relating to the computing resources of the first entity, a future malicious activity associated with the second attack relating to the computing resources of the second entity. The method further includes generating an alert for the predicted future malicious activity associated with the second attack relating to the computing resources of the second entity. The alert includes one or more attributes of a previous alert generated for one of the plurality of first malicious activities associated with the first attack relating to the computing resources of the first entity.

### TECHNICAL FIELD

Aspects and implementations of the present disclosure relate to computer security, and in particular to proactively generating alerts related to malicious activity with respect to computing devices.

### BACKGROUND

Computing devices such as data centers and cloud computing platforms may be susceptible to malicious activity (e.g., malware, network-based attacks). Malicious activity can lead to interruption or inefficient operation of computing devices, which can be problematic for owners and operators of computing devices. In extreme cases, malicious activity can damage computing devices or data stored thereon, potentially causing substantial financial loss and other losses and liabilities for the owners and operators of computing devices.

Security platforms typically have malicious activity notification mechanisms in place that alert clients when potential malicious activity is detected. The malicious activity can then be mitigated, e.g., by blocking a malicious file from being downloaded, stopping malicious processes that are running, etc. Reviewing and acting on malicious activity alerts is often a manual and time-consuming process for security professionals, which can result in human errors and can strain the human resources of security teams, thereby decreasing the overall effectiveness and threat coverage of the security platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for proactive security alert generation across organizations. In an implementation, a method includes detecting a plurality of first malicious activity associated with a first attack. The first attack relates to computing resources of a first entity. The method further includes detecting a plurality of second malicious activities associated with a second attack. The second attack relates to computing resources of a second entity that is distinct from the first entity. The method further includes predicting, based on the plurality of first malicious activities associated with the first attack relating to the computing resources of the first entity, a future malicious activity associated with the second attack relating to the computing resources of the second entity. The computing resources of the first entity are inaccessible to the second entity. The method further includes generating an alert for the predicted future malicious activity associated with the second attack relating to the computing resources of the second entity. The alert includes one or more attributes of a previous alert generated for one of the plurality of first malicious activities associated with the first attack relating to the computing resources of the first entity.

In some embodiments, the plurality of first malicious activities includes a first malicious activity and a second malicious activity. The plurality of second malicious activities includes a third malicious activity. Predicting the future malicious activity includes calculating a similarity score between the first malicious activity and the third malicious activity.

In some embodiments, calculating the similarity score includes comparing a first metadata of the first malicious activity to a corresponding second metadata of the second malicious activity to obtain a first difference value. Calculating the similarity score also includes comparing a third metadata of the first malicious activity to a corresponding fourth metadata of the second malicious activity to obtain a second difference value. Calculating the similarity score also includes combining the first difference value and the second difference value to obtain the similarity score.

In some embodiments, calculating the similarity score includes applying a clustering algorithm to the first malicious activity to obtain a first cluster and applying the clustering algorithm to the second malicious activity to obtain a second cluster. Calculating the similarity score also includes calculating a distance between the first cluster and the second cluster, the distance representing the similarity score.

In some embodiments, the plurality of first malicious activities corresponds to a first sequence of malicious activities, the first malicious activity preceding the second malicious activity in the first sequence. The plurality of second malicious activities corresponds to a second sequence of malicious activities, the third malicious activity being the last malicious activity in the second sequence.

In some embodiments, the first sequence of malicious activities is generated using a machine learning model trained to generate sequences of malicious activities given an input plurality of malicious activities.

In some embodiments, the one or more attributes of the previous alert generated for one of the plurality of first malicious activities associated with the first attack includes at least one of a severity value, a priority value, a risk value, a confidence value, or a malicious activity metadata.

In some embodiments a computer-readable storage medium (which may be a non-transitory computer-readable storage medium, although the invention is not limited to that) stores instructions which, when executed, cause a processing device to perform operations comprising a method according to any embodiment or aspect described herein.

In some embodiments a system comprises: a memory device; and a processing device operatively coupled with the memory to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system for proactive security alert generation across organizations, in accordance with at least one embodiment.

FIG. 2A depicts an example clustering of malicious activities, in accordance with at least one embodiment.

FIG. 2B depicts an example sequencing of malicious activities, in accordance with at least one embodiment.

FIG. 3 depicts a flow diagram of an example method of proactive security alert generation across organizations, in accordance with at least one embodiment.

FIG. 4 is a block diagram illustrating an exemplary computer system, in accordance with at least one embodiment of the present disclosure.

### DETAILED DESCRIPTION

Threat indicators may indicate past or current malicious activities with respect to computing resources. Computing resources may include, for example, servers, data centers, and cloud computing resources. Various computing resources may be susceptible to malicious activity. Examples of malicious activity include installation or operation of malware (e.g., malicious software), accessing or attempting to access computing resources without permission or authorization, modifying or exfiltrating data stored on computing resources without permission or authorization, exhausting computing resources (e.g., a denial-of-service attack), and other forms of unwanted activity. Malicious activity is often problematic for owners and operators of computing resources because the malicious activity can lead to interruption or inefficient operation of computing resources, or in extreme cases, substantial financial loss and liabilities. Malware is used herein as an example of malicious activity, but malicious activity often involves many other components such as those mentioned above, which are also within the scope of the present disclosure.

A security platform may provide services for detecting malicious activity with respect to computing resources, enabling timely mitigation before the malicious activity causes significant harm. For example, a security platform may receive data from computing resources (e.g., system event logs or new files inbound from a network connection) and analyze the data for signs of malicious activity. Detection rules may associate patterns in the data with different types of malicious activity, and rule evaluation engines may evaluate rules on new data. Upon evaluating a rule and detecting potential malicious activity, the security platform can issue an alert to the computing resources (e.g., via an application programming interface (API)) or to the owners and operators of the computing resources (e.g., via email). The malicious activity can then be automatically or manually mitigated in a timely manner, such as by blocking a malicious file from being downloaded, stopping malicious processes that are running, etc. Security information and event management (SIEM) systems are examples of security platforms and may include software, hardware, and managed service components. In conventional security platforms, alerts are not generated for malicious activity until after the malicious activity (and the resulting harm) has already occurred.

Aspects of the present disclosure address the above and other deficiencies by providing frameworks for proactive security alert generation across organizations. For example, a security platform such as a SIEM system may detect malicious activity associated with a first attack (e.g., one or more related malicious activities). The first attack may be directed to computing resources of a first entity (e.g., first organization). The malicious activities of the first attack may be combined into a first group (e.g., cluster, sequence). The security platform may detect malicious activity associated with a second attack. The second attack may be directed to computing resources of a second entity (e.g., second organization). The malicious activities of the second attack may be combined into a second group (e.g., cluster, sequence). If the second group is similar to the first group (e.g., based on one or more similarity calculations, such as comparing attributes of the malicious activities in each group) and if the second group has fewer malicious activities than the first group, a prediction of future malicious activity may be made. The predicted future malicious activity (or activities) may be related to the malicious activity that is in the first group and not in the second group. A proactive alert may be generated for the predicted future malicious activity. The alert may include one or more attributes (e.g., severity value, priority value, risk value, confidence value, malicious activity metadata, etc.) from an alert previously generated in relation to the malicious activity of the first group.

Advantages of the disclosed embodiments over the existing technology include but are not limited to generation of security alerts prior to the occurrence of malicious activity, resulting in reduced misuse of computing resources. Thus, a security platform and/or computing resources of an entity may experience reduced operating costs and improved performance including improved latency and throughput, which may benefit clients as well as increase trust in the security platform.

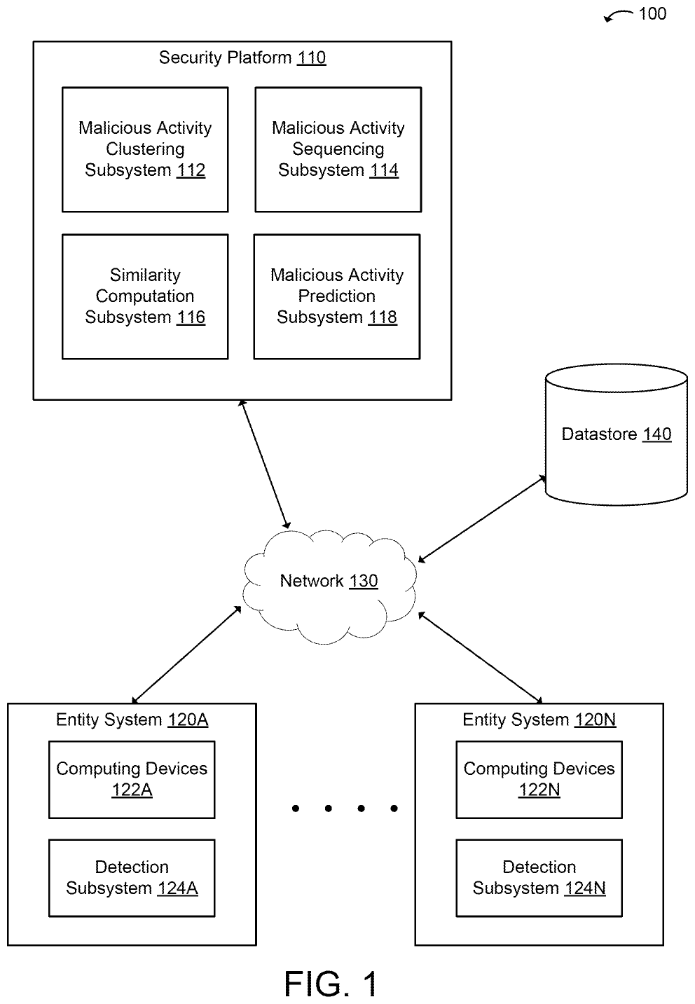

FIG. 1 illustrates an example system 100 for proactive security alert generation across organizations, in accordance with at least one embodiment. System 100 may include security platform 110, one or more entity systems 120A-N, and datastore 140 connected to network 130, such as a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

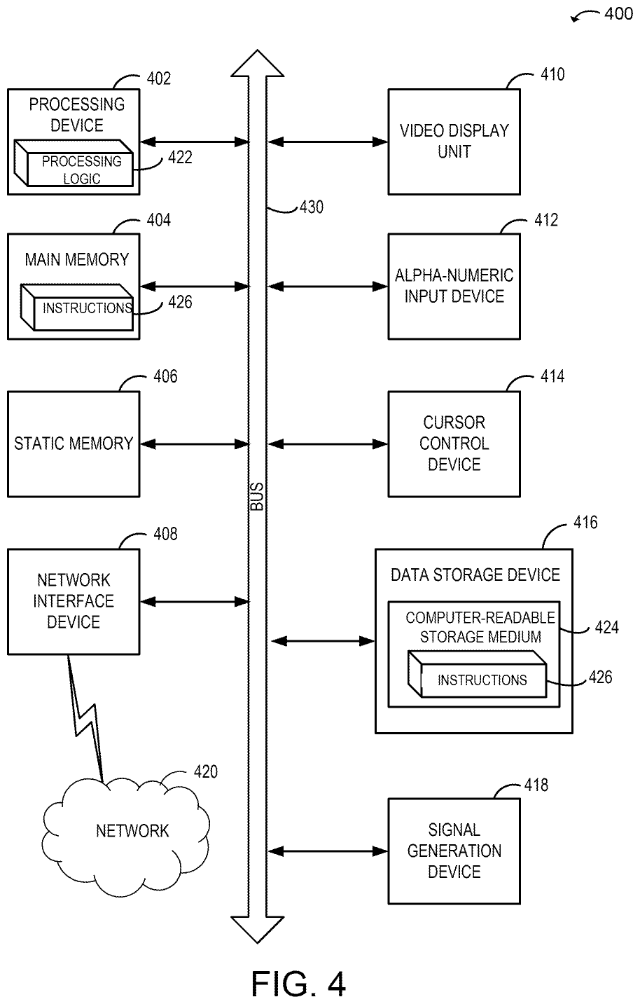

Entity systems 120A-N may each include computing resources of an entity (e.g., an organization) such as computing devices 122A-N, and detection subsystem 124A-N. Computing devices 122A-N may include one or more processing devices, volatile and non-volatile memory, data storage, one or more input/output peripherals such as network interfaces. FIG. 4 illustrates an example architecture of computing devices. In some embodiments, computing devices 122A-N may be singular devices such as smartphones, tablets, laptops, desktops, workstations, edge devices, embedded devices, servers, network appliances, security appliances, etc. In some embodiments, computing devices 122A-N may comprise multiple devices of similar or varying architecture such as computing clusters, data centers, co-located servers, enterprise networks, geographically disparate devices connected via virtual private networks (VPNs), etc. In some embodiments, computing devices 122A-N may comprise hardware devices such as those just described, virtual resources such as virtual machines (VMs) and containerized applications, or a combination of hardware and virtual resources.

Detection subsystem 124A-N may include one or more detection rules and/or detection models trained to identify malicious activity. Detection subsystem 124A-N may read system logs, event logs, and/or other data sources to identify potential malicious activity. System and/or event logs may include data (e.g., telemetry data) generated by computing devices 122A-N and/or corresponding software during execution regarding metrics, measurements, events, etc. pertaining to computing devices 122A-N and/or corresponding software. Upon detecting malicious activity, detection subsystem 124A-N may generate an alert based on the configured detection rule and/or detection model that identified the malicious activity, and/or may store data identifying the detected malicious activity and/or properties of the alert in a datastore such as datastore 140.

In some embodiments, entity system 120A-N is part of an entity's data center that includes computing devices 122A-N. Detection subsystem 124A-N can be part of the entity's data center or be located outside of the entity's data center (e.g., in a cloud computing environment). In other embodiments, entity system 120A-N is a part of a cloud computing environment having computing devices 122A-N assigned to the entity, and including detection subsystem 124A-N.

Security platform 110 can provide services for predicting malicious activity with respect to computing resources of entity systems 120A-120N. Security platform 110 may include malicious activity clustering subsystem 112, malicious activity sequencing subsystem 114, similarity computation subsystem 116, and/or malicious activity prediction subsystem 118. In some implementations, security platform 110 is part of a cloud computing environment that provides computing resources to various entities.

Malicious activity clustering subsystem 112 may receive (e.g., from detection subsystems 124A-N) one or more malicious activities with associated metadata (e.g., timestamp, target resource, source internet protocol (IP) address, network, filename, email address, email body, etc.). Using a clustering algorithm (e.g., k-means, BIRCH, gaussian mixture model, etc.), the malicious activities may be grouped into one or more clusters. In some embodiments, all malicious activities in a cluster are related to computing resources of a single entity. In some embodiments, malicious activities in a cluster are related to computing resources of more than one entity. In some embodiments, malicious activities of a cluster relate to a single attack (e.g., group of related malicious activities).

When two clusters (e.g., a first cluster from a first entity and a second cluster from a second entity) are determined to be similar (e.g., by similarity computation subsystem 116), one or more malicious activities may be predicted (e.g., by malicious activity prediction subsystem 118) and one or more corresponding alerts may be generated. For example, if a malicious activity is in one cluster but not the other, a prediction may be made that similar malicious activity will be found in the future in the other cluster. An alert may be generated related to the predicted future malicious activity so the malicious activity can be mitigated before it occurs.

Malicious activity sequencing subsystem 114 may receive one or more malicious activities with associated metadata (e.g., timestamp, target resource, source IP address, network, filename, email address, email body, etc.). The malicious activities may be grouped into one or more sequences (e.g., ordered list of malicious activities). In some embodiments, all malicious activities in a sequence are related to computing resources of a single entity. In some embodiments, malicious activities in a sequence are related to computing resources of more than one entity. In some embodiments, malicious activities of a sequence relate to a single attack (e.g., group of related malicious activities).

In some embodiments, malicious activity sequencing subsystem 114 may sequence the malicious activities based on timestamps of the malicious activities. In some embodiments, the malicious activities may be ordered based on an attack phase that corresponds to the malicious activity (e.g., initial access, reconnaissance, execution, discovery, lateral movement, collection, command and control, exfiltration, etc.). In some embodiments, malicious activities may be sequenced by a user (e.g., security analyst). In some embodiments, malicious activities may be sequenced by a machine learning model trained to generate a sequence of malicious activities given an input plurality of malicious activities. In some embodiments, a decision tree algorithm (e.g., categorical variable decision tree, continuous variable decision tree, etc.) may be used for sequencing.

When two sequences (e.g., a first sequence from a first entity and a second sequence from a second entity) are determined to be similar (e.g., by similarity computation subsystem 116), one or more malicious activities may be predicted (e.g., by malicious activity prediction subsystem 118) and one or more corresponding alerts may be generated. For example, if a malicious activity is in one sequence but not the other, a prediction may be made that similar malicious activity will be found in the future in the other sequence. An alert may be generated related to the predicted future malicious activity so the malicious activity can be mitigated before it occurs.

Similarity computation subsystem 116 may receive two (or more) malicious activities and may determine a similarity score indicative of how similar the malicious activities are to one another. Similarity computation subsystem 116 may compare metadata of a first malicious activity to metadata of a second malicious activity to determine the similarity score. Malicious activities may be considered similar if the distance between one or more metadata fields satisfies a similarity threshold criterion. Some distances may be calculated based on the absolute value of subtraction of numerical fields. Some distances (e.g., for fields with text values) may be calculated based on the minimum number of single-character edits (e.g., insertions, deletions, substitutions) required to change one word into the other (e.g., Levenshtein distance). Some distances may be calculated based on a comparison of one or more substrings of the field (e.g., filename, file extension, complete file path, etc.). Some distances may be calculated based on a distance between embedded values.

In some embodiments, a neural network (e.g., an auto encoder) may convert a malicious activity (or malicious activity metadata) into an encoding within an embedding space. A distance between a first malicious activity and a second malicious activity may be calculated by computing a distance between a first encoding corresponding to the first malicious activity metadata and a second encoding corresponding to the second malicious activity metadata.

The distance between the one or more fields of the malicious activities may be combined to obtain a similarity score. The distances may be combined by calculating a sum of the distances (e.g., a sum of a first distance and a second distance), by calculating a max value of the distances, by calculating an average of the distances, or by calculating a linear combination of the distances. For example, each field may have an associated weight that is combined with (e.g., multiplied) the field distance when calculating the combined distance. In some embodiments, distances are normalized, and the final distance is the root mean square of individual distances per field. In some embodiments, an alternative distance calculation is used, such as Jaro distance, longest common sequence distance, cosine distance, Euclidean distance, and the like.

In some embodiments, similarity computation subsystem 116 may determine a similarity between two (or more) groups of malicious activities (e.g., two clusters, two sequences). In some embodiments, two groups of malicious activities may be considered similar if one or more of the malicious activities in the groups are similar (e.g., have a similarity score that satisfies a threshold criterion). In some embodiments, two groups of malicious activities may be considered similar if the combined similarity scores of the malicious activities within each group satisfies a threshold criterion.

In some embodiments, when comparing two sequences, one or more decision tree algorithms (e.g., categorical variable decision tree, continuous variable decision tree, etc.) may be used to determine a similarity of the sequences.

Malicious activity prediction subsystem 118 may predict future malicious activity and generate corresponding alerts based on the groups created by malicious activity clustering subsystem 112 and malicious activity sequencing subsystem 114 and based on the similarity scores determined by similarity computation subsystem 116. For example, if two groups are considered similar by similarity computation subsystem 116 and the first group has one (or more) malicious activity that is not present in the second group, malicious activity prediction subsystem 118 may predict that a similar malicious activity will be present in the second group in the future. Malicious activity prediction subsystem 118 may generate an alert corresponding to the predicted future malicious activity. The alert may have one or more properties, which may be based on an alert that was previously generated for the malicious activity in the first group that is similar to the predicted future malicious activity. For example, if the malicious activity in the first group had a corresponding alert with a high risk value (or severity value, priority value, confidence value, or other metadata), the alert generated for the predicted future malicious activity may have the same value. The alert properties may include metadata related to the predicted future malicious activity and/or metadata related to the malicious activity of the first group which may facilitate mitigation of the predicted future malicious activity.

In some embodiments, a cluster may include malicious activities with low severity values. For example, the malicious activities in the cluster may be false-positives that were flagged by security platform 110 and/or detection subsystems 122A-N and turned out to be benign. If malicious activity prediction subsystem 118 receives two similar groups, and one group is determined to be benign, predicted future malicious activity may also be considered benign and no alert may be generated for the predicted future malicious activity.

Datastore 140 may be a persistent storage that is capable of storing malicious activity predictions, malicious activity clusters, malicious activity sequences, malicious activity and/or associated metadata, event logs, alerts and/or associated metadata, neural network models, and the like. Datastore 140 may be hosted by one or more storage devices, such as main memory, magnetic or optical storage-based disks, tapes or hard drives, network attached storage (NAS), storage area network (SAN), and so forth. In some embodiments, datastore 140 may be a network-attached file server. In some embodiments, datastore 140 may be some other type of persistent storage such as an object-oriented database, a relational database, and so forth. In some embodiments, datastore 140 may be hosted on or may be a component of security platform 110. In some embodiments, datastore 140 may be provided by a third-party service such as a cloud platform provider.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether security platform 110 and detection subsystems 124A-N collect user information (e.g., information about a user's social network, social actions or activities, profession, a user's preferences, or a user's current location), or to control whether and/or how to receive content from the security platform 110 and detection subsystems 124A-N that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the security platform 110 and detection subsystems 124A-N.

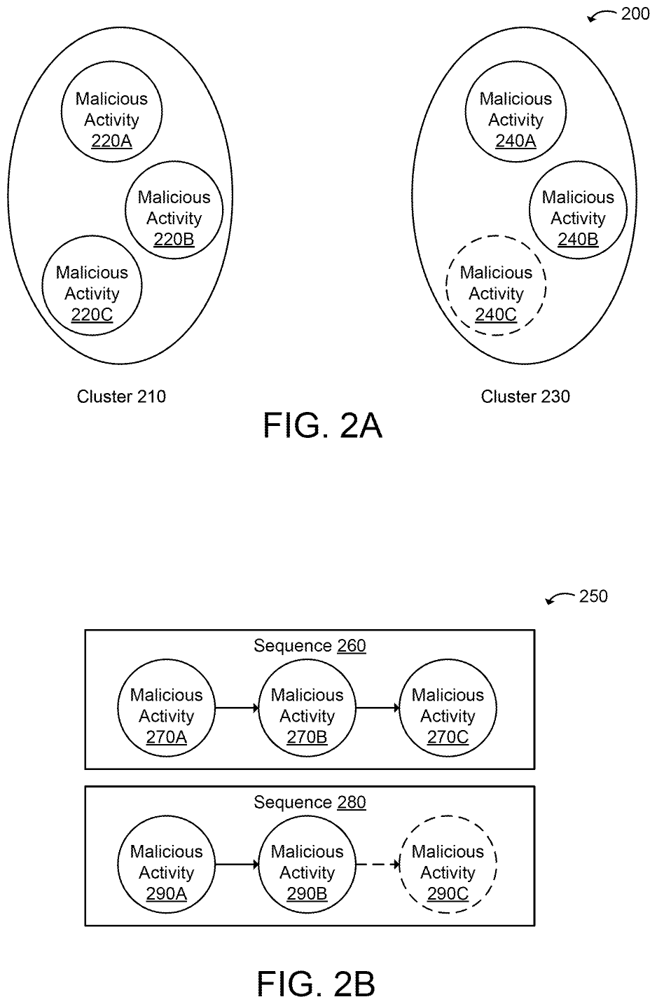

FIG. 2A depicts an example clustering 200 of malicious activities, in accordance with at least one embodiment. Clustering 200 may include cluster 210 and cluster 230. In some embodiments, cluster 210 corresponds to a first entity and cluster 230 corresponds to a second entity. Cluster 210 may include one or more malicious activities (e.g., malicious activities 220A-C). Each malicious activity may include one or more characteristics and/or metadata values. The malicious activities may be clustered based on their one or more characteristics and/or metadata values (e.g., source internet protocol (IP) address, target resource, timestamp, username, network, filename, email source, email body, etc.). In some embodiments, malicious activities are clustered using k-means clustering. In some embodiments, BIRCH clustering algorithm is used. In some embodiments, gaussian mixture model clustering algorithm is used. In some embodiments, another clustering algorithm is used. For example, malicious activity 220A, malicious activity 220B, and malicious activity 220C may have one or more shared (or similar) characteristics. In some embodiments, malicious activities are clustered based on one or more properties of alerts corresponding to the malicious activity. For example, malicious activities with corresponding high-severity alerts may be grouped in the same cluster. In some embodiments, malicious activity 220A, malicious activity 220B, and malicious activity 220C may all target the same computing resource of an entity. Because malicious activity 220A, malicious activity 220B, and malicious activity 220C have shared (or similar) characteristics, they may all be included within cluster 210.

Cluster 230 may include malicious activity 240A and malicious activity 240B. Cluster 230 may correspond to a second entity (e.g., malicious activity 240A and malicious activity 240B may be associated with computing resources of the second entity). In some embodiments, malicious activity of cluster 230 is similar to malicious activity of cluster 210. For example, malicious activity 240A may be similar to malicious activity 220A, and malicious activity 240B may be similar to malicious activity 220B. In some embodiments, malicious activity 240A may be similar to malicious activity 220B, and malicious activity 240B may be similar to malicious activity 220A. In some embodiments, similarity may be determined by similarity computation subsystem 116 of FIG. 1. After determining a similarity between malicious activities and/or clusters, future malicious activity may be predicted.

Future malicious activity may correspond to malicious activity that exists in one cluster but not the other cluster. For example, malicious activity 240C (depicted with a dashed outline) may not yet exist in cluster 230. Because malicious activities 240A and 240B are similar to malicious activities 220A and 220B of cluster 210, a prediction may be made that malicious activity 240C will be included in cluster 230 and may be similar to malicious activity 220C of cluster 210. An alert may be generated based on the prediction. For example, an alert may be generated for predicted malicious activity 240C, and the alert may include one or more attributes of an alert previously generated for malicious activity 220C of cluster 210. For example, if malicious activity 220C had an associated alert with a high severity value, the alert generated for predicted malicious activity 240C may also have a high severity value.

FIG. 2B depicts an example sequencing 250 of malicious activities, in accordance with at least one embodiment. Sequencing 250 may include sequence 260 and sequence 280. In some embodiments, sequence 260 corresponds to a first entity and sequence 280 corresponds to a second entity. Sequence 260 may include one or more malicious activities (e.g., malicious activities 270A-C) in an ordered list. Each malicious activity may include one or more characteristics and/or metadata values. The malicious activities may be sequenced based on their one or more characteristics and/or metadata values. For example, malicious activity 270A may be the first malicious activity in sequence 260 and may represent malicious activity that occurs during an early stage (or phase) of a malicious attack (e.g., reconnaissance, initial access, etc.). Malicious activity 270B may be the second malicious activity in sequence 260 and may represent malicious activity that occurs after malicious activity 270A (e.g., execution, discovery, lateral movement, etc.). Malicious activity 270C may be the third malicious activity in sequence 260 and may represent malicious activity that occurs after malicious activity 270B (e.g., collection, command and control, exfiltration, etc.). In some embodiments, a sequence may have more (or fewer) malicious activities. In some embodiments, the order of the malicious activities may be different. Malicious activities 270A-C may have shared (or similar) characteristics (e.g., may be related to the same malicious attack) and may be included in the same sequence (e.g., sequence 260).

Sequence 280 may include malicious activity 290A and malicious activity 290B. Sequence 280 may correspond to a second entity (e.g., malicious activity 290A and malicious activity 290B may be associated with computing resources of the second entity), which may be different than the entity corresponding to sequence 260. In some embodiments, malicious activity of sequence 280 is similar to malicious activity of sequence 260. For example, malicious activity 290A may be similar to malicious activity 270A, and malicious activity 290B may be similar to malicious activity 270B. In some embodiments, similarity may be determined by similarity computation subsystem 116 of FIG. 1. After determining a similarity between malicious activities and/or sequences, future malicious activity may be predicted.

Future malicious activity may correspond to malicious activity that exists in one sequence but not the other sequence. For example, malicious activity 290C (depicted with a dashed outline) may not yet exist in sequence 280. Because malicious activities 270A and 270B of sequence 260 are similar to malicious activities 290A and 290B of sequence 280, a prediction may be made that malicious activity 290C will be included in sequence 280 and may be similar to malicious activity 270C of sequence 260. An alert may be generated based on the prediction. For example, an alert may be generated for predicted malicious activity 290C, and the alert may include one or more attributes of an alert previously generated for malicious activity 270C of sequence 260. For example, if malicious activity 270C had an associated alert with a high risk value, the alert generated for predicted malicious activity 290C may also have a high risk value.

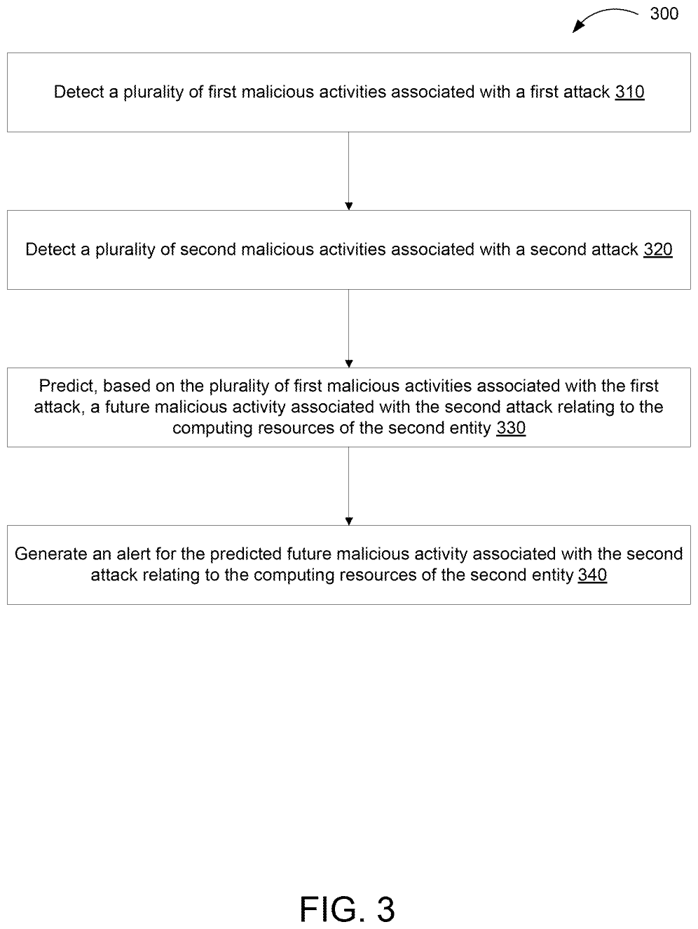

FIG. 3 depicts a flow diagram of an example method 300 of proactive security alert generation across organizations, in accordance with at least one embodiment. Method 300 can be performed by processing logic that can include hardware (circuitry, dedicated logic, etc.), software (e.g., instructions run on a processing device), or a combination thereof. In at least one implementation, some or all of the operations of method 300 can be performed by one or more components of system 100 for proactive security alerts across entity systems of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 310, processing logic may detect a plurality of first malicious activities associated with a first attack. The first attack may relate to computing resources of a first entity. The first entity may be a first organization or group of organizations, a first user or group of users, etc., and the computing resources may include one or more computing devices, networks, databases, and/or the like associated with the first entity.

At block 320, processing logic may detect a plurality of second malicious activities associated with a second attack. The second attack may relate to computing resources of a second entity that is distinct from the first entity.

At block 330, processing logic may predict, based on the first malicious activities associated with the first attack relating to the computing resources of the first entity, a future malicious activity associated with the second attack relating to the computing resources of the second entity. The computing resources of the first entity may be inaccessible to the second entity. For example, the computing resources of the first entity may be on a network separate from the computing resources of the second entity.

In some embodiments, the plurality of first malicious activities includes a first malicious activity and a second malicious activity. The plurality of second malicious activities may include a third malicious activity. Predicting the future malicious activity may include calculating a similarity score between the first malicious activity and the third malicious activity.

In some embodiments, to calculate the similarity score, processing logic may compare a first metadata of the first malicious activity to a corresponding second metadata of the third malicious activity to obtain a first difference value. Processing logic may further compare a third metadata of the first malicious activity to a corresponding fourth metadata of the third malicious activity to obtain a second difference value. Processing logic may further combine the first difference value and the second difference value to obtain the similarity score.

In some embodiments, to calculate the similarity score, processing logic may apply a clustering algorithm to the first malicious activity to obtain a first cluster and apply the clustering algorithm to the third malicious activity to obtain a second cluster. In some embodiments, malicious activities are clustered using k-means clustering. In some embodiments, BIRCH clustering algorithm is used. In some embodiments, gaussian mixture model clustering algorithm is used. In some embodiments, another clustering algorithm is used. Processing logic may further calculate a distance between the first cluster and the second cluster, the distance representing the similarity score.

In some embodiments, the plurality of first malicious activities may correspond to a first sequence of malicious activities. The first malicious activity may come before the second malicious activity in the first sequence. The plurality of second malicious activities may correspond to a second sequence of malicious activities. The third malicious activity may be the last malicious activity in the second sequence.

In some embodiments, the first sequence of malicious activities is generated using a machine learning model trained to generate sequences of malicious activities given an input plurality of malicious activities. For example, the trained machine learning model may order an input plurality of malicious activities by one or more characteristics of the malicious activities (e.g., timestamp, type of malicious activity, attack phase associated with the malicious activity, etc.). In some embodiments, the first sequence of malicious activities is generated by a user (e.g., a security analyst). For example, the user may be provided a set of malicious activities and may order the malicious activities to create the first sequence.

In some embodiments, the machine learning model is a generative artificial intelligence (AI) model, such as a large language model (LLM) allowing for the generation of new and original content. A generative AI model may include aspects of a transformer architecture, or a generative adversarial network (GAN) architecture. Such a generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space representation, generating outputs with increased novelty and uniqueness. The self-attention mechanism can compute the importance of phrases or words within a text data with respect to all of the text data. A generative AI model can also utilize deep learning techniques, including recurrent neural networks (RNNs), convolutional neural networks (CNNs), or transformer networks. A generative AI model can be pre-trained on a large corpus of data so as to process, analyze, and generate human-like text based on given input. Any of the AI models may have any typical architecture for LLMs, including one or more architectures as seen in Bidirectional Encoder Representations from Transformers (BERT), Generative Pre-trained Transformer series (Chat GPT series LLMs), or leverage a combination of transformer architecture with pre-trained data to create coherent and contextually relevant text.

The machine learning model may be trained by a training engine. In some implementations, model training can be supervised, and each set of training data can include a subset of training inputs and target outputs based on the identified data. To train a supervised model, training data may be generated that includes a subset of training inputs and a subset of target outputs. The subset of training inputs can include questions, and a subset of target outputs can include responses (which in some cases may be textual responses). In some implementations, a subset of training inputs can include responses and a subset of target outputs can include a question. In some implementations, training data may be generated by an LLM that accepts responses and generates similar descriptions based on the input of the responses for a particular question. In some implementations, model training can be unsupervised. To train an unsupervised model, training data may be generated by clustering groups of historical responses based on similarities between the historical responses, through dimensionality reduction by reducing the number of features in the data while retaining as much relevant information about the historical responses as possible, by generating synthetic or partially synthetic data that resembles the original data, through anomaly detection by identifying parts of content items that are significantly different from the rest of the data, or through data augmentation by applying mathematical transformations to the training dataset.

In some embodiments, the machine learning model can be trained by adjusting weights of a neural network in accordance with a backpropagation learning algorithm or the like. The machine learning model can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc.

At block 340, processing logic may generate an alert for the predicted future malicious activity associated with the second attack relating to the computing resources of the second entity. The alert may include one or more attributes of a previous alert generated for one of the plurality of first malicious activities associated with the first attack relating to the computing resources of the first entity.

In some embodiments, the one or more attributes of the previous alert generated for one of the plurality of first malicious activities associated with the first attack include at least one of a severity value, a priority value, a risk value, a confidence value, or a malicious activity metadata. Predicted future malicious activity is based on similar past malicious activity (e.g., based on malicious activity clustering, based on malicious activity sequencing, etc.). Because the future malicious activity is (expected to be) similar to past malicious activity, an alert for the predicted future malicious activity is (expected to be) similar to an alert for the past malicious activity. For example, if an alert for the past malicious activity had a high severity value, the alert for the predicted future malicious activity may also have a high severity value.

FIG. 4 is a block diagram illustrating an exemplary computer system, in accordance with at least one embodiment of the present disclosure. The computer system 400 can correspond to security platform 110 and/or entity system 120A-N, described with respect to FIG. 1. Computer system 400 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 416, which communicate with each other via a bus 430.

Processor (processing device) 402 represents one or more general-purpose processing devices such as a microprocessor, central processing unit, or the like, and may include processing logic 422. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for proactive security alert generation across organizations) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker). In some embodiments, computer system 400 may not include video display unit 410, input device 412, and/or cursor control device 414 (e.g., in a headless configuration).

The data storage device 416 can include a non-transitory machine-readable storage medium 424 (also computer-readable storage medium) on which is stored one or more sets of instructions 426 (e.g., for proactive security alert generation across organizations) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for proactive security alert generation across organizations. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
detecting a plurality of first malicious activities associated with a first attack, wherein the first attack relates to computing resources of a first entity;
detecting a plurality of second malicious activities associated with a second attack, wherein the second attack relates to computing resources of a second entity that is distinct from the first entity;
predicting, based on the plurality of first malicious activities associated with the first attack relating to the computing resources of the first entity, a future malicious activity associated with the second attack relating to the computing resources of the second entity, wherein the computing resources of the first entity are inaccessible to the second entity; and
generating an alert for the predicted future malicious activity associated with the second attack relating to the computing resources of the second entity, the alert comprising one or more attributes of a previous alert generated for one of the plurality of first malicious activities associated with the first attack relating to the computing resources of the first entity.

2. The method of claim 1, wherein:
the plurality of first malicious activities comprises a first malicious activity and a second malicious activity;
the plurality of second malicious activities comprises a third malicious activity; and
predicting the future malicious activity comprises calculating a similarity score between the first malicious activity and the third malicious activity.

3. The method of claim 2, wherein calculating the similarity score comprises:
comparing a first metadata of the first malicious activity to a corresponding second metadata of the third malicious activity to obtain a first difference value;
comparing a third metadata of the first malicious activity to a corresponding fourth metadata of the third malicious activity to obtain a second difference value; and
combining the first difference value and the second difference value to obtain the similarity score.

4. The method of claim 2, wherein calculating the similarity score comprises:
applying a clustering algorithm to the first malicious activity to obtain a first cluster;
applying the clustering algorithm to the third malicious activity to obtain a second cluster; and
calculating a distance between the first cluster and the second cluster, the distance representing the similarity score.

5. The method of claim 2, wherein the plurality of first malicious activities corresponds to a first sequence of malicious activities, the first malicious activity preceding the second malicious activity in the first sequence; and wherein the plurality of second malicious activities corresponds to a second sequence of malicious activities, the third malicious activity being the last malicious activity in the second sequence.

6. The method of claim 5, wherein the first sequence of malicious activities is generated using a machine learning model trained to generate sequences of malicious activities given an input plurality of malicious activities.

7. The method of claim 1, wherein the one or more attributes of the previous alert generated for one of the plurality of first malicious activities associated with the first attack relating to the computing resources of the first entity comprises at least one of:
a severity value;
a priority value;
a risk value;
a confidence value; or
a malicious activity metadata.

8. A system comprising:
a memory device; and
a processing device coupled to the memory device, the processing device to perform operations comprising:
detecting a plurality of first malicious activities associated with a first attack, wherein the first attack relates to computing resources of a first entity;
detecting a plurality of second malicious activities associated with a second attack, wherein the second attack relates to computing resources of a second entity that is distinct from the first entity;
predicting, based on the plurality of first malicious activities associated with the first attack relating to the computing resources of the first entity, a future malicious activity associated with the second attack relating to the computing resources of the second entity, wherein the computing resources of the first entity are inaccessible to the second entity; and
generating an alert for the predicted future malicious activity associated with the second attack relating to the computing resources of the second entity, the alert comprising one or more attributes of a previous alert generated for one of the plurality of first malicious activities associated with the first attack relating to the computing resources of the first entity.

9. The system of claim 8, wherein:
the plurality of first malicious activities comprises a first malicious activity and a second malicious activity;
the plurality of second malicious activities comprises a third malicious activity; and
predicting the future malicious activity comprises calculating a similarity score between the first malicious activity and the third malicious activity.

10. The system of claim 9, wherein calculating the similarity score comprises:
comparing a first metadata of the first malicious activity to a corresponding second metadata of the third malicious activity to obtain a first difference value;
comparing a third metadata of the first malicious activity to a corresponding fourth metadata of the third malicious activity to obtain a second difference value; and
combining the first difference value and the second difference value to obtain the similarity score.

11. The system of claim 9, wherein calculating the similarity score comprises:
applying a clustering algorithm to the first malicious activity to obtain a first cluster;
applying the clustering algorithm to the third malicious activity to obtain a second cluster; and
calculating a distance between the first cluster and the second cluster, the distance representing the similarity score.

12. The system of claim 9, wherein the plurality of first malicious activities corresponds to a first sequence of malicious activities, the first malicious activity preceding the second malicious activity in the first sequence; and wherein the plurality of second malicious activities corresponds to a second sequence of malicious activities, the third malicious activity being the last malicious activity in the second sequence.

13. The system of claim 12, wherein the first sequence of malicious activities is generated using a machine learning model trained to generate sequences of malicious activities given an input plurality of malicious activities.

14. The system of claim 8, wherein the one or more attributes of the previous alert generated for one of the plurality of first malicious activities associated with the first attack relating to the computing resources of the first entity comprises at least one of:
a severity value;
a priority value;
a risk value;
a confidence value; or
a malicious activity metadata.

15. A non-transitory computer-readable storage medium comprising instruction that, when executed by a processing device, cause the processing device to perform operations comprising:
detecting a plurality of first malicious activities associated with a first attack, wherein the first attack relates to computing resources of a first entity;
detecting a plurality of second malicious activities associated with a second attack, wherein the second attack relates to computing resources of a second entity that is distinct from the first entity;
predicting, based on the plurality of first malicious activities associated with the first attack relating to the computing resources of the first entity, a future malicious activity associated with the second attack relating to the computing resources of the second entity, wherein the computing resources of the first entity are inaccessible to the second entity; and
generating an alert for the predicted future malicious activity associated with the second attack relating to the computing resources of the second entity, the alert comprising one or more attributes of a previous alert generated for one of the plurality of first malicious activities associated with the first attack relating to the computing resources of the first entity.

16. The non-transitory computer-readable storage medium of claim 15, wherein:
the plurality of first malicious activities comprises a first malicious activity and a second malicious activity;
the plurality of second malicious activities comprises a third malicious activity; and
predicting the future malicious activity comprises calculating a similarity score between the first malicious activity and the third malicious activity.

17. The non-transitory computer-readable storage medium of claim 16, wherein calculating the similarity score comprises:
comparing a first metadata of the first malicious activity to a corresponding second metadata of the third malicious activity to obtain a first difference value;
comparing a third metadata of the first malicious activity to a corresponding fourth metadata of the third malicious activity to obtain a second difference value; and
combining the first difference value and the second difference value to obtain the similarity score.

18. The non-transitory computer-readable storage medium of claim 16, wherein calculating the similarity score comprises:
applying a clustering algorithm to the first malicious activity to obtain a first cluster;
applying the clustering algorithm to the third malicious activity to obtain a second cluster; and
calculating a distance between the first cluster and the second cluster, the distance representing the similarity score.

19. The non-transitory computer-readable storage medium of claim 16, wherein the plurality of first malicious activities corresponds to a first sequence of malicious activities, the first malicious activity preceding the second malicious activity in the first sequence; and wherein the plurality of second malicious activities corresponds to a second sequence of malicious activities, the third malicious activity being the last malicious activity in the second sequence.

20. The non-transitory computer-readable storage medium of claim 15, wherein the one or more attributes of the previous alert generated for one of the plurality of first malicious activities associated with the first attack comprises at least one of:
a severity value;
a priority value;
a risk value;
a confidence value; or
a malicious activity metadata.
